(19) United States
(12) Patent Application Publication
(10) Pub. No.: US 2008/0317567 A1
(43) Pub. Date: Dec. 25, 2008

(54) Automatic handling of multiplex storage-goods carriers

(76) Inventors: Michael Rother, Rheinzabern (DE); Bernhard Sproll, Kuhardt (DE)

Correspondence Address: Mark P. Stone, 4th Floor, 25 Third Street,, Stamford, CT, 06905, US

(21) Appl. No.: 12/151,965

(22) Filed: May 9, 2008

(30) Foreign Application Priority Data
Jun. 22, 2007 (DE) 10 2007 029308.0

(51) Int. Cl. B65G 67/00; A47F 7/00

(52) U.S. Cl. 414/340; 414/807; 211/49.1

(57) ABSTRACT

A method of automatically depositing and withdrawing storage-goods carriers (2) in and from a storage rack (4, 4′) with the aid of transport vehicles (1) is improved according to the invention in that at least two storage-goods carriers (2) are stored each in a first and at least one other storage level (28) one upon the other on a transport vehicle (1), the transport vehicle (1) is driven near the storage rack (4, 4′) and positioned in a transfer position (U) at the storage rack (4, 4′), and subsequently the storage-goods carriers of the first and then of the at least one other storage level (28) are deposited in or withdrawn from the storage rack (4, 4′) in the transfer position (U), wherein a relative difference of level (ΔY) between a working level (E) of a transfer device (3, 36, 36′) and the respective storage levels (28) of the storage-goods carriers (2) is automatically compensated for deposition and withdrawal. The invention furthermore relates to a transport vehicle (1) for transporting several storage-goods carriers (2) arranged one upon the other in storage levels (28) to or away from a storage rack (4, 4′), and a storage rack (4, 4′) for storing storage-goods carriers (2) in at least one storage level (28′), wherein the transport vehicle (1) can be aligned with at least one positioning means (19, 20) at a counter-position means (19, 19′) to be assigned to the storage rack (4, 4′) in a transfer position (U), and wherein the storage rack (4, 4′) is provided with a transfer device (3, 36, 36′) the working level (E) of which can be relatively brought to the same level as a first and at least one other storage level (28) arranged one upon the other on the transport vehicle (1), by which transfer device one can access a load carrier (2) stored in the first and/or at least one second storage level (28) of the transport vehicle (1) in the transfer position (U).

The invention relates to a method of automatically depositing and withdrawing storage-goods carriers in or from a storage rack, wherein at least two storage-goods carriers are stored each in a first and at least one other storage level on a transport vehicle one upon the other, the transport vehicle is driven near the storage rack and positioned at the storage rack in a transfer position (U), and subsequently the storage-goods carriers of the first and then of the at least one other storage level are deposited in or withdrawn from the storage rack in the transfer position (U), a relative difference of level (ΔY) between a working level (E) of a transfer device and the respective storage levels of the storage-goods carriers being automatically compensated for deposition and withdrawal. The invention furthermore relates to transport vehicles for transporting storage-goods carriers to a storage rack or away from the same, having at least two storage levels for the storage-goods carriers arranged one upon the other, a positioning means which is designed such that it can be aligned with a counter-positioning means which can be assigned to the storage rack and by which the transport vehicle can be positioned in a defined transfer position (U) at the storage rack, wherein in the transfer position (U), the storage-goods carriers can be deposited in or withdrawn from their storage levels one after the other. The invention furthermore relates to a storage rack for storing storage-goods carriers, having at least one storage level, at least one counter-positioning means cooperating with at least one positioning means at a transport vehicle, wherein the transport vehicle can be aligned with said counter-positioning means in a transfer position (U), and a transfer device the working level (E) of which can be relatively brought to one level with a first and at least one other storage level arranged one upon the other on the transport vehicle, by which transfer device one can access a load carrier stored in the first and/or at least one second storage level of the transport vehicle in the transfer position (U).

Storage racks and transport vehicles are known as parts of automatic or semi-automatic storage systems. With the transport vehicles, goods stored on storage-goods carriers or trays are often transported to the storage racks and picked up from them. In the transport racks, the storage-goods carriers are stored in various storage levels arranged one upon the other. The storage levels can in most cases be variably used depending on the height of the goods stored on the trays, so that available storage space can be efficiently utilized despite differing heights of storage goods and a very high storage density can be achieved. Within the storage racks, the storage-goods carriers are in most cases moved automatically in the horizontal and vertical directions by so-called vertical conveyors. The storage racks equipped with vertical conveyors are then also referred to as storage lifts.

These storage lifts often comprise a loading and unloading opening into which the storage-goods carriers can be placed or pushed to then be picked up by the vertical conveyor and brought to their predetermined storage locations. Vice versa, requested storage-goods carriers are transferred from their storage locations to the loading and unloading opening with the vertical conveyor.

The storage-goods carriers are manually or more often automatically deposited in or withdrawn from the loading and unloading openings by means of a transport vehicle. To this end, horizontal conveyor devices which pull the storage-goods carriers from the transport vehicle are installed in the loading and unloading openings.

The transport vehicle is either manually or increasingly automatically driven near the loading and unloading opening. That means, there is a certain traffic volume of transport vehicles bringing and picking up storage-goods carriers around a storage system using transport vehicles. This traffic volume is increasing as the deposition and withdrawal activities are increasing, resulting in an increasing number of logistic problems.

With manually as well as with mechanically or automatically guided transport vehicles, a logistic problem can arise, for example, if these line up or gather around a loading and unloading opening of a storage lift as the individual transport vehicles cannot be approached to the loading and unloading opening and loaded and/or unloaded quickly enough. Another logistic problem results from the plurality of transport vehicles around a storage lift which is in most cases installed in a production building or at a production line. The plurality of transport vehicles can block the paths in the production building or transport connections established around the storage lift and be an encumbrance to other users of these paths.

A further logistic problem is that in particular for automatically driven and controlled transport vehicles, in some cases fixed paths are prescribed some of which are even defined as one-way streets. On these paths, the transport vehicles then have to accept longer distances, so to speak drive the complete round in which they are sent to a storage lift with a storage good request or storing instruction and from which they are called back again. With these longer distances, in particular the loading capacity of the transport vehicles is a limiting factor. Due to the limited storage capacity of the transport vehicles, the required number thereof is in turn increased, and thus the traffic volume and the logistic efforts for the operation thereof are in turn increased.

Consequently, the object underlying the invention is to improve a method of automatically depositing and withdrawing storage-goods carriers in or from a storage rack with the aid of transport vehicles, which method is mentioned in the beginning.

In a method according to the invention, this object is achieved in that at least two storage-goods carriers are stored in a first and at least one other storage level one upon the other on a transport vehicle and the transport vehicle is driven near the storage rack and positioned at the storage rack in a transfer position (U), and subsequently the storage-goods carriers of the first and then of the at least one other storage level are deposited or withdrawn in the transfer position, wherein a relative difference of level (ΔY) between a working level (E) of a transfer device and the respective storage levels of the storage-goods carriers for the deposition and withdrawal is automatically compensated.

This simple solution is advantageous in that several storage levels with a difference of level (ΔY) are available on the transport vehicle, thus increasing the storage capacity of the transport vehicle. If such transport vehicles according to the invention are employed in a storage system, their number can be reduced due to their increased storage capacities. At the same time, the time required for the deposition and withdrawal at the loading and unloading openings of the storage racks is reduced because several storage-goods carriers at a time can be deposited in and withdrawn from a transport vehicle positioned in the transfer position (U).

This solution according to the invention can be combined and further improved as desired with the following further procedure steps which are each advantageous alone.

Thus, according to a first possible advantageous improvement of a method according to the invention it can be provided that the transfer position (U) is confirmed by means of a positioning means at the transport vehicle and/or the rack storage. Such positioning means can be mounted, for example, as proximity switches or magnets in the bottom in front of or directly at the loading and unloading opening of a storage rack or at the transport vehicle itself There, they assist in guiding the transport vehicle with high precision to the transfer position (U) and in generating a confirming signal in the transfer position (U). From the generation of this electrical signal on, further procedure steps can then be released or awaited, which permits to structure and design a method according to the invention as secure as possible.

According to a further possible advantageous procedure step, it can be provided that the transport vehicle's readiness for unloading is confirmed with the aid of a positioning means at the transport vehicle and/or the rack storage. This procedure step can follow, for example, the confirmation of the transfer position (U). This ensures that the storage rack or the transfer device as well as the transport vehicle are ready for the deposition and withdrawal processes. This is in particular advantageous if for carrying out the deposition and withdrawal processes any push-out protections or catch hooks which secure the storage-goods carriers in their storage levels in the transport vehicle or on the transfer device have to be released, so that the storage-goods carriers are not improperly or incompletely removed from or introduced into the transport vehicle or the transfer device.

The confirmation of the transfer position (U) at the storage rack by the transport vehicle or vice versa as well as the confirmation of the readiness for unloading at the transport vehicle or the transfer device or vice versa can be utilized as release for the deposition and withdrawal process.

The confirmations of the transfer positions and readiness for unloading can also be used for signaling the completion of a loading and unloading processes when positioning means employed at the storage rack and the transport vehicle report the driving out of the transport vehicle and/or a transfer device from the transfer position (U).

The above mentioned confirmation processes can be advantageously used in particular if according to a further possible procedure step it is provided that the transport vehicle is automatically positioned in the transfer position (U). The automatic positioning can be performed by a self-propelled transport vehicle itself or by an auxiliary device coupled to the transport vehicle. This auxiliary device can be, for example, a guide module at the transfer device or the storage rack which takes over the transport vehicle from a predetermined approach position to the loading and unloading opening and guides it precisely into the transfer position (U).

The loading and unloading processes of the transport vehicle can be performed quickly in particular if it is provided according to a further possible advantageous improvement of a method according to the invention that the storage-goods carriers are pushed into and/or out of the storage levels of the transport vehicle with the aid of a horizontal conveying device. Pushing in and out represents a simple and elegant possibility of moving the storage-goods carriers. For pushing in and/or out, the horizontal conveying device can include appropriate gripping means which can be applied to the load carrier to pull it out of its respective storage level or push it to a level predetermined for it.

For preventing a load carrier from unintentionally slipping from its storage level, according to a further possible advantageous procedure step it can be provided that a push-out protection is released before the storage-goods carriers are pushed in and/or out. As already mentioned, this push-out protection can be released during a confirmation process for the release of the transfer position Such a push-out protection can be controlled purely mechanically or else electrically and should essentially act across an introduction direction (Z) of the storage-goods carriers in that it grips behind the load carrier and is caught or latched in a defined storage position.

According to a further possible advantageous procedure step, it can be provided that in the transfer position (U) at the latest, a data carrier is read in and/or out at the transport vehicle and/or the storage-goods carriers. The data carrier can contain some information about the type and destination of the storage-goods carriers and the goods stored on them. The data carrier can also contain information saying in which storage positions storage-goods carriers are stored on the transport vehicle. For reading the data carrier in and out, a data transmission device, such as a radio or infrared transmitter, can be attached to the storage rack or the transfer device, which can, for example, acquire information about the storage-goods carriers to be deposited or withdrawn already at a certain distance from the transport vehicle, if this is desired.

Furthermore, the data carrier itself can also be employed as positioning means and a loading and unloading processes of the storage-goods carriers only initiated if certain data stored in the data carrier have been transmitted.

According to a further possible advantageous improvement of a method according to the invention, it can be provided that upon the approach of the transport vehicle to the storage rack, light grille elements at the storage rack are switched on. This switching on can be triggered by proximity sensors or other light grille elements or light barriers or motion detectors. With this, the storage rack and the transfer device can also be set to readiness, which, however, can also have been performed by the transmission of a certain radio signal via a data transmission device at the transport vehicle or the storage rack.

The light grille at the storage rack can assist in detecting storage-goods carriers stored in the transport vehicle. Apart from their number and storage positions, the height of the goods stored on the storage-goods carriers can also be determined with the aid of the light grille.

Moreover, the light grille can perform a safety function in that it detects any objects or persons within a certain safety area around the loading and unloading opening and thereupon intervenes in the procedure. For example, the speed of a transport vehicle can be slowed down or the transport vehicle, a horizontal conveyor or any other movable units of the storage rack or the transport vehicle can be switched off or secured by doors, flaps or barriers.

According to a further possible advantageous improvement of a method according to the invention it can be provided that the transfer device and/or the storage levels of the transport vehicle are moved with a lifting means in the vertical direction H to deposit or withdraw the storage-goods carriers in or from their respective storage levels of the transport vehicle. Thus, the transfer device can be mounted on a lifting scissors table or a vertical conveyor which moves to the respective storage levels on the transport vehicle. It is also conceivable that a lifting means is installed in the transport vehicle itself to drive the storage levels of the transport vehicle to a certain working height of a transfer device.

In particular if a transfer device is mounted on a vertical conveyor, it is advantageous if according to a further possible improvement of a method according to the invention it is provided that the transport vehicle drives into an entrance in a storage rack. Thus, the transport vehicle does not block the area in front of the storage rack during the deposition and withdrawal of the storage-goods carriers. In the rack, the transport vehicle can be positioned in its transfer position securely and without external disturbing influences. This also reduces the risks for persons and objects emanating from elements of a storage lift, a transfer device or a transport vehicle as it is more difficult for the persons and objects to enter a danger zone between the transport vehicle and the transfer device if the complete transport vehicle drives into the storage lift.

It is possible to close an entrance to a storage lift by a suited barrier, such as, for example a rolling door, so that improper interventions in the storage lift or a loading and unloading process are stopped. It would after all be possible that a person or a machine pushes the transport vehicle out of its transfer position during the loading and unloading process, which, however, seems to be more improbable if the transport vehicle is situated within a storage lift.

The driving of a transport vehicle into a storage rack or the approaching of the transport vehicle to a transfer device can be facilitated according to a further possible improvement of a method according to the invention if it is provided that the driving of the transport vehicle into the entrance is guided by at least one run-in aid at the entrance. This run-in aid can, for example, taper like a funnel towards the entrance or at least the transfer device and guide the transport vehicle to the entrance or to the transfer device.

This measure can also be advantageous in connection with a further possible improvement of a method according to the invention according to which during an approach of the transport vehicle to the transfer device the accuracy of the determination of the position of the transport vehicle is increased. In particular in automatically guided transport vehicles, the position of the transport vehicle has to be determined as accurately as possible during its travel through its site of application. However, there are certain economical and technical limits to the determination of the position. It is therefore advantageous if the determination of the position is adjusted according to the respective accuracy demands. As in particular during the deposition and withdrawal of the storage-goods carriers very high accuracy is necessary, the accuracy of the determination of the position should be increased at the latest when the transport vehicle is guided into its transfer position at the transfer device.

This procedure is in particular advantageous if according to a further possible improvement of a method according to the invention it is provided that the transport vehicle is driven to the transfer device by an external drive unit. This external drive unit can then use any auxiliary devices, such as positioning devices or other optic or magnetic identifications on the travel to the storage rack in or at the loading and unloading opening or entrance into the storage rack to precisely drive the transport vehicle into the transfer position (U).

The use of an external drive unit can also increase the efficiency of the use of transport vehicles as not every transport vehicle has to be provided with suited position finding, referencing and drive systems and energy supply devices.

Correspondingly, a storage system according to the invention can be operated with a plurality of transport vehicles and a rather smaller number of external drive units if it is provided according to a further possible advantageous improvement of a method according to the invention that the external drive unit is coupled to the transport vehicle before the transport vehicle is moved. The external drive unit can then transport a transport vehicle to a storage rack on demand or pick it up from a storage rack Here, certain priorities according to which the external drive unit gives priority to working off a certain transport vehicle before other transport vehicles can also be implemented.

According to a further possible method-improving step it can also be provided that the external drive unit is uncoupled at the latest in the transfer position of the transport vehicle. Here, the external drive unit can transfer the control of the transport vehicle to the storage rack or a transfer device and take care of other jobs. Thus, the external drive unit can also bridge longer deposition and withdrawal processes.

This approach can also be advantageous if a position finding or guiding of the transport vehicle is anyway ensured near a transfer device or in an entrance to a storage rack by the guiding and positioning means installed there.

The loading and unloading of a transport vehicle can be facilitated according to a further possible improvement of a method according to the invention in that at least one storage level of the transport vehicle is folded away from the storage levels located below it for loading and unloading a storage level located below. Thus, any storage goods can also be manually or mechanically stored or even poured into storage levels covered by storage levels located above. This is in particular advantageous for manual loading and unloading if storage-goods carriers pushed into the transport vehicle cannot be pulled out of the transport vehicle or pushed into it manually.

The above object is achieved with respect to a transport vehicle according to the invention in that the same comprises at least two storage levels for storage-goods carriers arranged one upon the other and positioning means designed so as to be aligned with counter-positioning means which can be associated to the storage rack, by which positioning means the transport vehicle can be positioned in a transfer position at the storage rack, wherein in the transfer position the storage-goods carriers can be deposited in or withdrawn from their storage levels one after the other. The transport vehicle according to the invention accordingly has an increased storage capacity as it comprises several storage levels and can additionally be positioned precisely thus permitting a quick deposition and withdrawal of storage-goods carriers on the transport vehicle.

A transport vehicle according to the invention can be improved according to a first possible embodiment in that the transport vehicle is provided with a data carrier on which information about at least one load carrier stored on the transport vehicle and/or requested by the transport vehicle can be read in and/or out. This data carrier can contain precise information about the goods and storage-goods carriers stored on the transport vehicle. With this, the storage-goods carriers and the goods stored on them can be quickly assigned to the storage levels in the storage rack and on the transport vehicle thus facilitating a sending and requesting of the storage-goods carriers in a storage system according to the invention.

According to another possible advantageous embodiment of a transport vehicle according to the invention, the same can comprise at least one storage level which is fixed to the transport vehicle by means of at least one hinge so that it can be tilted. Thus, levels located below this transport level can be reached without having to pull out or withdraw the storage-goods carriers stored on the transport vehicle.

According to another possible advantageous embodiment of a transport vehicle according to the invention, at least one storage level can be formed by at least one supporting profile. Such a supporting profile can be particularly easily formed if the at least one supporting profile is formed at a wall element. Thus, between two wall elements provided with supporting profiles, one accommodation room of the transport vehicle can be formed in which the storage-goods carriers are stored variably according to a height of the respective goods stored on them, and the storage can be compacted on the transport vehicle.

According to a further possible embodiment of a transport vehicle according to the invention, it can be advantageous if at at least one storage level at least one light grille element is arranged. This light grille element can be used to detect the storage-goods carriers stored in the various levels of the transport vehicle as well as the heights of the goods stored on the storage-goods carriers. Here, several ones of these light grille elements or light barriers or else other suited proximity switches or electronic detection elements, respectively, can be employed for forming a detection system on the transport vehicle for the storage-goods carriers that can be deposited in the various storage levels and the goods stored on the storage-goods carriers. Thus, the transport vehicle itself can detect information about the storage-goods carriers stored on it, such as the height of the storage goods, and transmit them to a transfer device or a storage rack, respectively, for example by means of a data transmission device.

According to another possible advantageous embodiment of a transport vehicle according to the invention, the same can comprise lifting means with which at least one storage level of the transport vehicle can be moved in a vertical direction (Y). Thus, a difference of level (ΔY) between the storage levels of the transport vehicle can also be overcome with the lifting means mounted in the transport vehicle to achieve a relative adjustment to the working level E of the transfer device.

For a storage rack mentioned in the beginning, the above object is achieved in that this storage rack is provided with at least one storage level having a counter-positioning means cooperating with a positioning means at a transport vehicle, and a transfer device the working level (E) of which can be relatively brought to the same level with a first and at least one other storage level arranged one upon the other on the transport vehicle, by which transfer device one can access a load carrier stored in the first and/or the at least second storage level of the transport vehicle in the transfer position (U). Thereby, the storage-goods carriers can be deposited and withdrawn in various levels of a transport vehicle which are located one upon the other with the transfer device and taken from the storage rack and deposited in the same.

The storage rack according to the invention can be improved according to a first possible advantageous embodiment in that the transfer device is provided with at least one lifting means. By the lifting means, the working level (E) of the transfer device can be moved in the vertical direction (Y) to a relative equal height of a load carrier to be deposited on or withdrawn from a storage level of the transport vehicle.

According to a further possible advantageous embodiment of a storage rack according to the invention, the at least one transfer device can be arranged at least partially in an interior of the storage rack that has at least one entrance into which at least a part of the transport vehicle can be driven until the transfer position (U) is reached. Thus, a vertical conveyor handling the storage levels of the storage rack in the storage rack can also be employed for depositing and withdrawing the storage-goods carriers in the various levels of the transport vehicle located one upon the other. Simultaneously, the loading and unloading processes with a transport vehicle that has been driven into the entrance are better protected from incidents by persons or objects influencing the transport vehicle or the transfer device.

Below, the invention will be illustrated by way of example more in detail by means of advantageous embodiments with reference to the drawings. The described embodiments here only represent possible embodiments, where, however, the individual features, as described above, can be realized independently from one another and can also be omitted.

In the drawings:

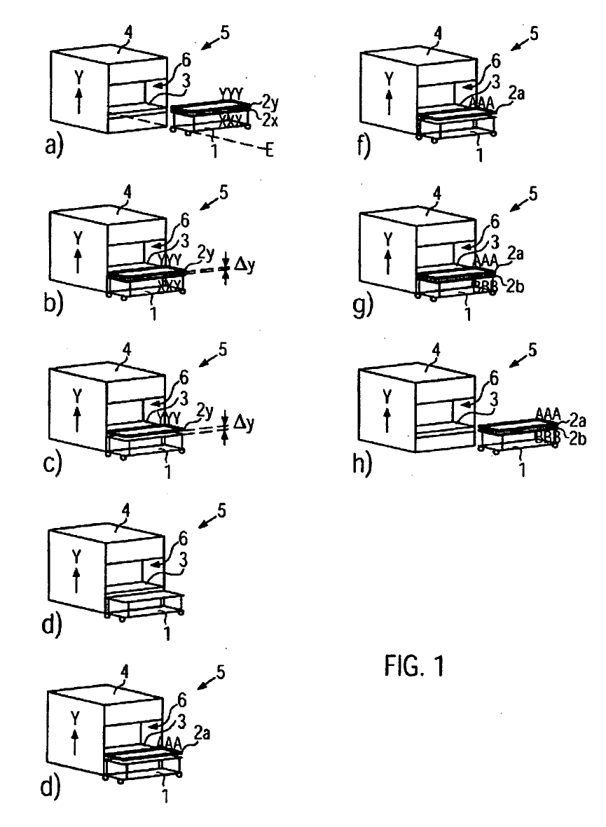

FIG. 1 shows a process diagram for a deposition and withdrawal processes according to the invention;

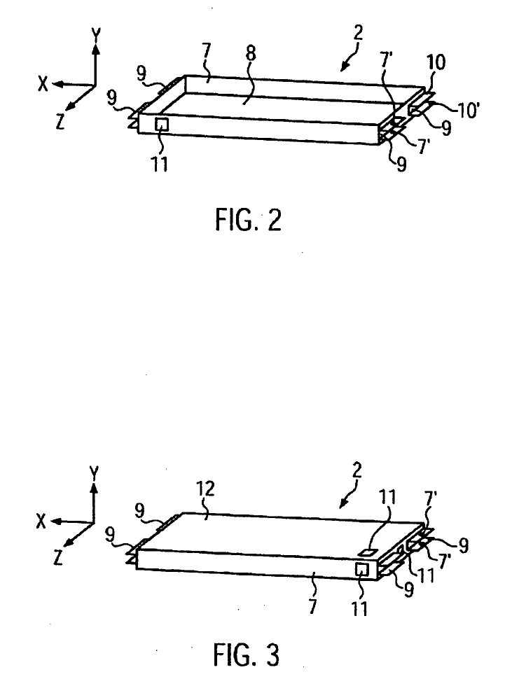

FIG. 2 shows a schematic perspective view of a load carrier;

FIG. 3 shows a schematic perspective view of the bottom side of the load carrier of FIG. 2;

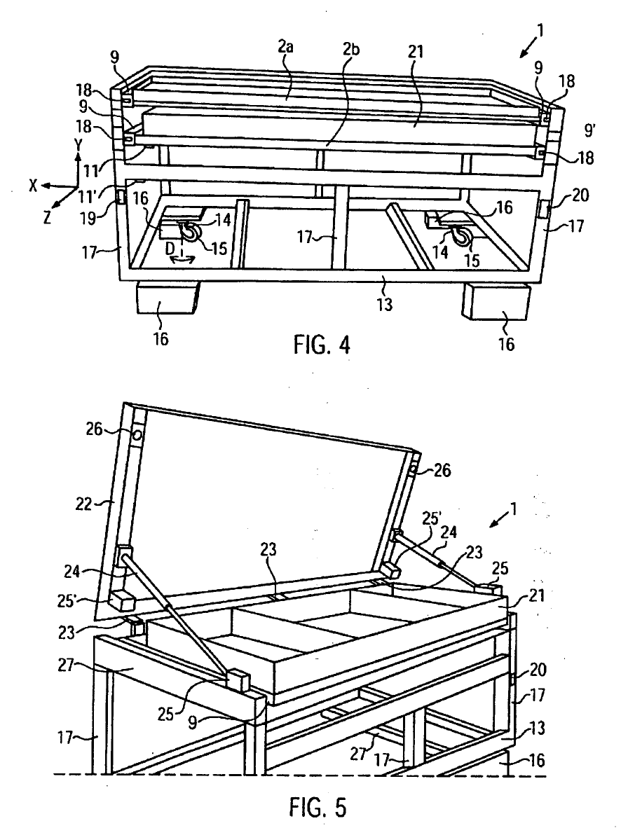

FIG. 4 shows a schematic perspective view of a transport vehicle according to the invention;

FIG. 5 shows a schematic perspective view of a transport vehicle according to the invention with tilted storage level;

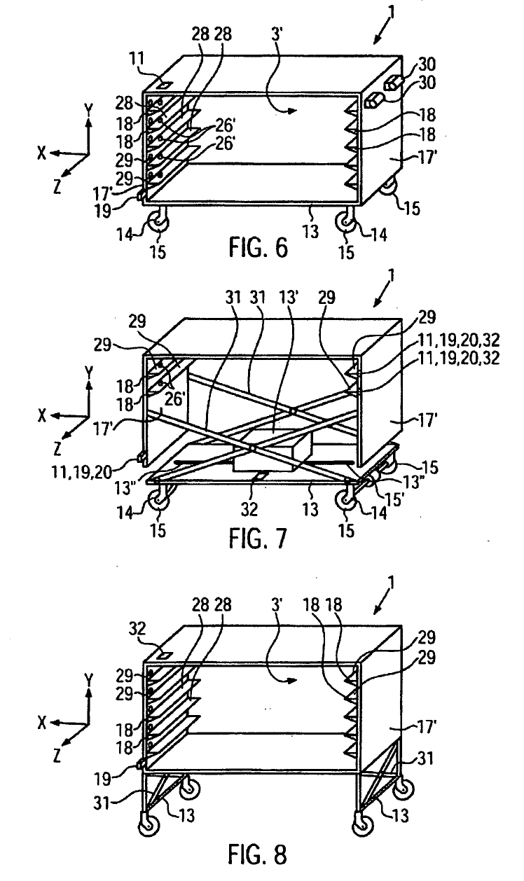

FIG. 6 shows a schematic perspective view of a transport vehicle according to the invention;

FIG. 7 shows a schematic perspective view of a transport vehicle according to the invention with a lifting function;

FIG. 8 shows a schematic perspective view of a transport vehicle according to the invention with a lifting function;

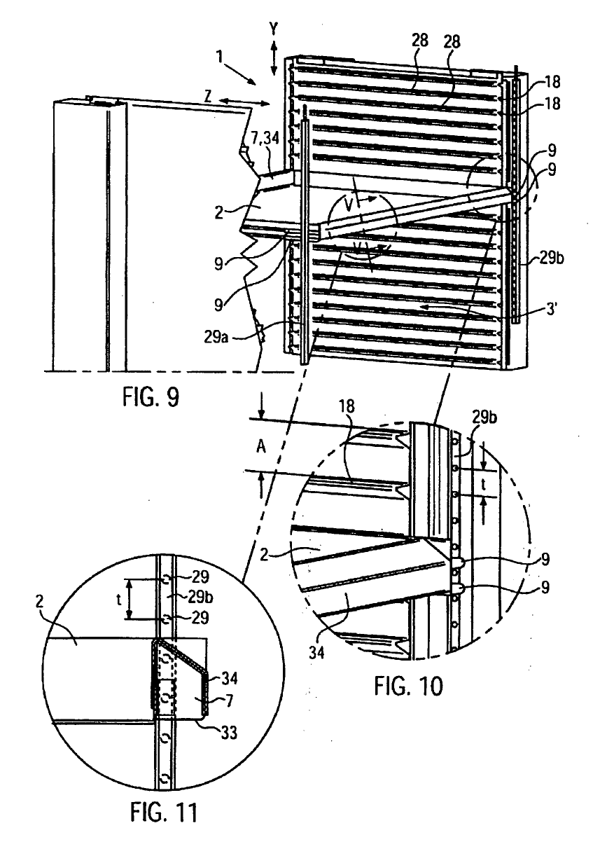

FIG. 9 shows a schematic perspective view of a screen wall with a light grille;

FIG. 10 shows an enlarged partial view of the detail IV of the schematic perspective view of the screen wall with light grille of FIG. 9;

FIG. 11 shows an enlarged side view of the light grille of FIG. 9 along the cutting line V-V;

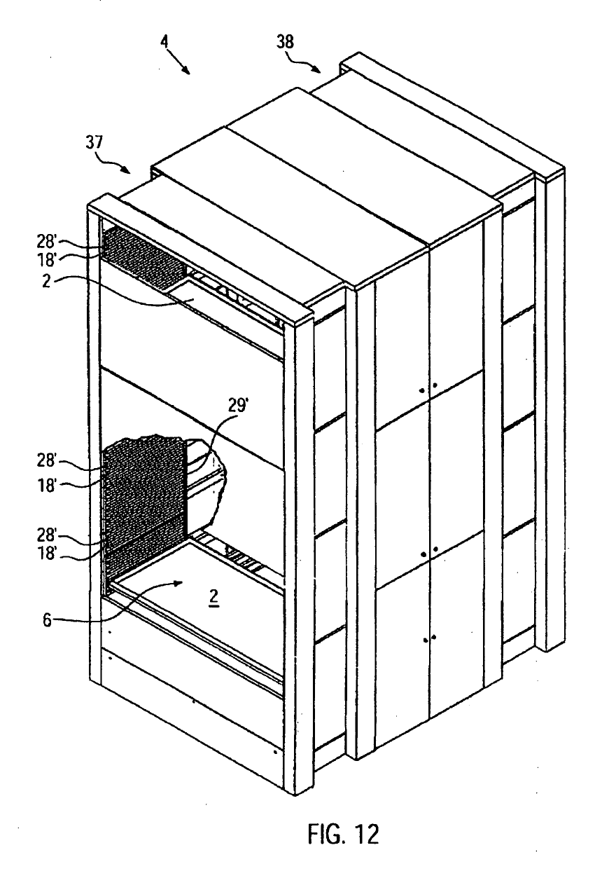

FIG. 12 shows a schematic perspective view of a storage rack;

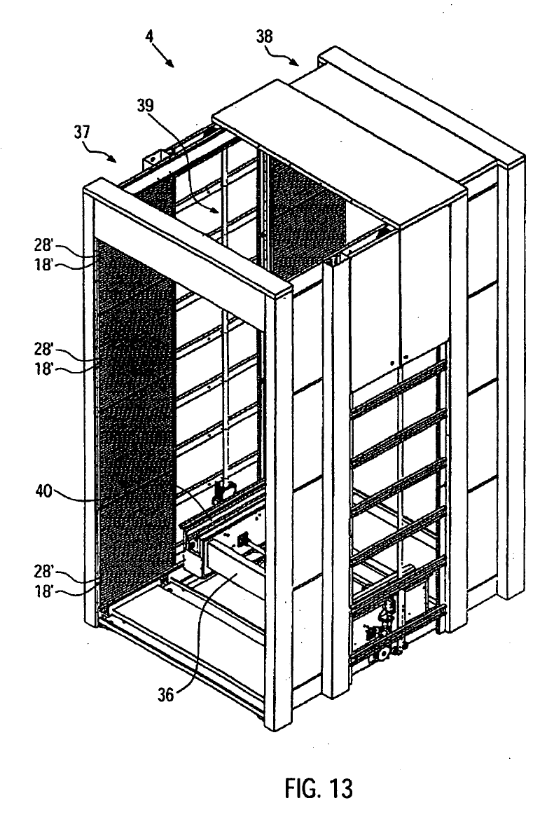

FIG. 13 shows a schematic perspective view of the storage rack in FIG. 12 with partially removed covers;

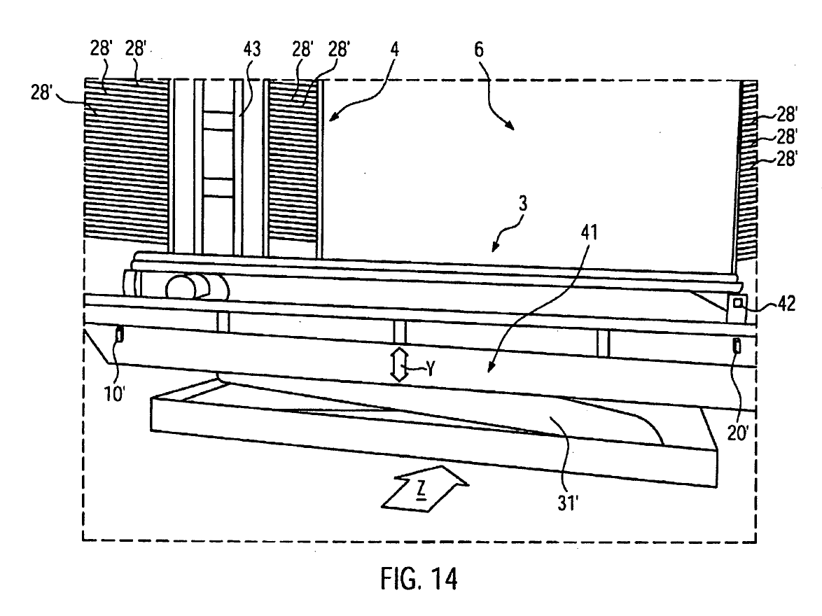

FIG. 14 shows a schematic perspective view of a transfer device according to the invention;

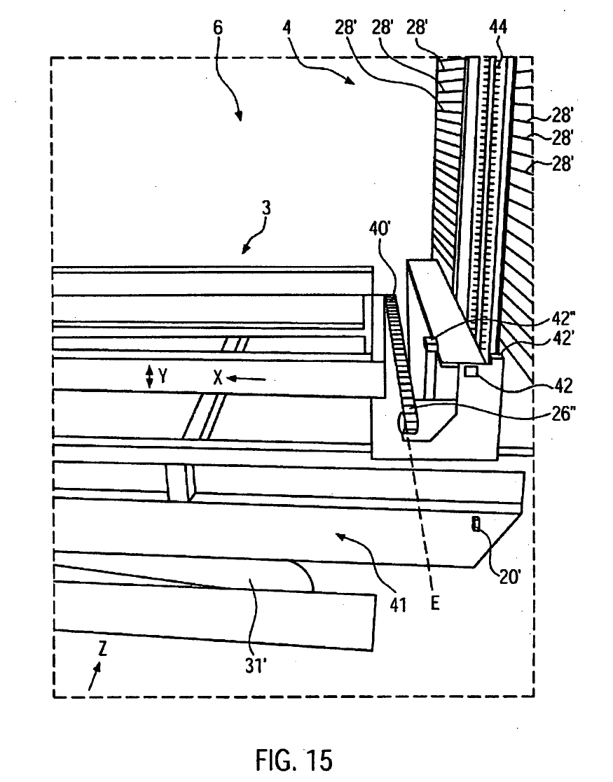

FIG. 15 shows a detail of the schematic perspective view of the transfer unit in FIG. 14;

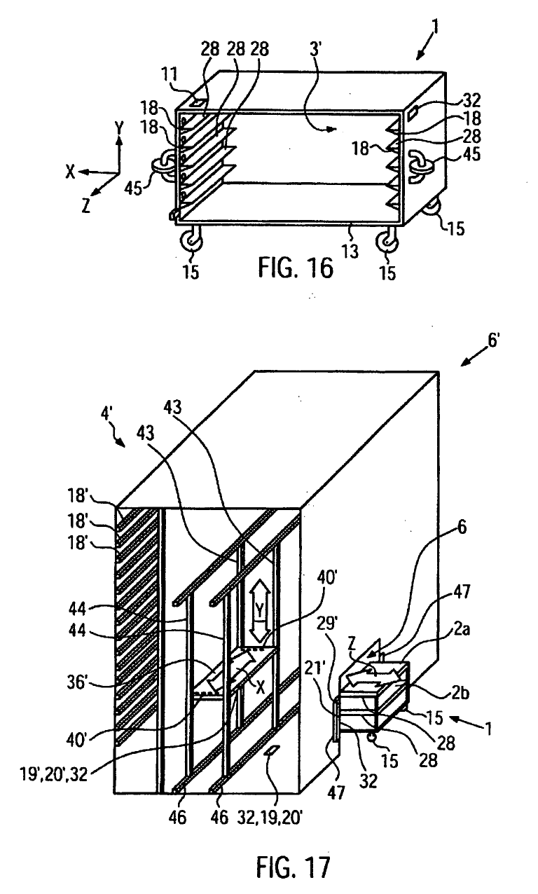

FIG. 16 shows a schematic perspective view of a transport vehicle according to the invention;

FIG. 17 shows a schematic perspective view of a storage rack according to the invention with a transport vehicle that is driving in.

First, an embodiment of a method according to the invention for depositing and withdrawing storage-goods carriers 2 transported on a transport vehicle 1 by means of a transfer device 3 into a storage rack 4 is described with reference to FIG. 1. FIG. 1 shows possible procedure steps a) to h) of a method according to the invention depositing and withdrawing storage-goods carriers 2 of a storage system 5 according to the invention, wherein the storage-goods carriers 2 are transported to a storage rack 4 and picked up from the storage rack 5 on a transport vehicle 1.

In a procedure step a), a transport vehicle 1 loaded with two storage-goods carriers 2x, 2y is driving to a storage rack 4. The load carrier 2y is stored on the transport vehicle above the load carrier 2x. The storage-goods carriers 2x, 2y are to be deposited into the storage rack 4 by means of the working level E of the transfer device 3 in a loading and unloading opening 6 of the storage rack 4.

In a possible procedure step b), the transport vehicle 1 has been driven in front of the loading and unloading opening 6. The transfer device 3 is located in a vertical direction Y from its working level E on the height of the load carrier 2x which is located below the load carrier 2y by a difference of level ΔY. The transport device is ready to pull the load carrier 2x out of the transport vehicle 1.

In a possible procedure step c), the load carrier 2x is pulled out of the transport vehicle 1 and already deposited in the storage rack 4. The transfer device 3 has moved to the height of the second load carrier 2y and is ready to transfer the same to the storage rack 4.

In a possible procedure step d), the second load carrier 2y, too, has been pulled from the transport vehicle 1 and transferred to the storage rack 4. The transport vehicle 1 is ready for being supplied again with storage-goods carriers 2.

In a next possible procedure step e), a load carrier 2a has been pushed from the loading and unloading opening 6 of the storage rack 4 onto the transport vehicle 1 by the transfer device 3.

This load carrier 2a requested by the transport vehicle 1 can be empty or loaded with storage goods to be withdrawn.

In a possible procedure step f), the transfer device 3 has driven again downwards and is ready to deposit a load carrier 2 requested by the transport vehicle 1 under the load carrier 2a in the transport vehicle 1.

In a further possible procedure step g), a second load carrier 2b is deposited underneath the first load carrier 2a in the transport vehicle.

In a last possible procedure step h) shown here, the transport vehicle 1 drives away from the storage rack 4 with two storage-goods carriers 2a, 2b requested by it.

In FIG. 2, a load carrier 2 is shown in a schematic perspective view. The load carrier 2 has a storage area 8 surrounded by an edge 7. Laterally, supporting webs 9 essentially extending at the load carrier 2 in an introduction direction Z of the load carrier 2 are fixed to the edge 7 of the load carrier 2. The supporting webs 9 comprise two legs 10, 10′ spaced apart in the vertical direction Y and extending in a horizontal direction X.

Push-out protections 7′ are mounted to the legs 10, 10′ in the form of holes or cavities 7′. A suited catching means (not shown here) at a transport vehicle 1 can grip behind these push-out protections 7′, so that the storage-goods carriers 2 cannot be unintentionally shifted.

Furthermore, at the edge 7 around the storage area 8, a data carrier 11 pointing in the introduction direction Z is mounted externally. Information about the goods stored on the load carrier 2 can be stored in the data carrier 11. These information can include, for example, the type of the stored goods, their order, piece or part numbers, or else any dates, such as dates of delivery, dates of expiry or use-by dates. Furthermore, these information can also include statements about the type and properties of the stored goods, such as their weight, dimensions, such as in particular storage height, and any storage prescriptions.

The data carrier 11 can be a Radio Frequency Identification chip (RF-ID) 11 or any other data carrier 11, such as an infrared chip, a Bluetooth chip or else a data carrier to be read out optically, such as for example an infrared chip or a simple bar code.

In FIG. 3, the load carrier 2 which is shown in FIG. 2 is shown upside down, so that a bottom side 12 of the load carrier 2 points upwards. Here it becomes clear that a data carrier 11 can also be mounted to the bottom side 12 or at an external wall 7 of the load carrier 2 pointing in the horizontal direction X. At the external wall 7 of the load carrier 2, the data carrier can also be mounted, for example, between two supporting webs 9. Data carriers 11 mounted to the side wall or the edge 7 of the load carrier 2 in the introduction direction Z or the horizontal direction X as well as data carriers mounted on the bottom side 12 thereof can have an additional function as positioning aid.

It is not absolutely necessary to attach two of the supporting webs 9 with a subdivision at the external wall 7 of the load carrier 2 pointing in the horizontal direction X, but this offers the possibility of attaching a data carrier 11 between the webs 9 or of simply saving material for the supporting webs 9. The supporting webs 9 can be attached to the load carrier by means of a form-fit connection, such as rivets or screws, but they can also be integrally formed of the material of the load carrier 2.

In FIG. 4, a transport vehicle 1 according to the invention is shown in a schematic perspective view. The transport vehicle 1 comprises an undercarriage 13. The undercarriage 13 is situated about an axis of revolution D at a suspension 14 of rotatably supported casters 15. The casters or wheels 15 are attached in such a way that they orient in a possible moving direction B of the vehicle 1 according to a plane spanned by the horizontal direction X and the introduction direction Z. Furthermore, the casters are surrounded by a cover 16. The cover 16 protects any persons or objects from being rolled over and protects the casters 15 from being damaged when they hit or roll over any obstacles.

Vertical supports 17 are mounted on the undercarriage 13. The vertical supports 17 can be fixed to the undercarriage 13 by a form-fit connection method, such as riveting or screwing, but also by material connection methods, such as soldering or welding. Supporting profiles 18 essentially extending in parallel to the introduction direction Z are attached to the vertical supports 17, which can be, as the vertical supports, connected to the vertical supports 17 or the undercarriage 13, respectively, with a form-fit and/or a material connection Storage-goods carriers 2a, 2b are resting with their supporting webs 9 on the supporting profiles 18. The storage-goods carriers 9 can be deposited in and withdrawn from the transport vehicle 1 in the introduction direction Z.

Furthermore, one can see in FIG. 4 that a data carrier 11 is attached below the load carrier 2b. Equally, a data carrier 11′ can be attached to the transport vehicle 1 itself This data carrier 11′ can contain information about the storage-goods carriers 2 deposited in the transport vehicle 1 or requested by the same.

A positioning aid 19 attached to a vertical support 17 facilitates precise positioning of the transport vehicle 1. The positioning aid 19 can be identified by a corresponding counter part and submit precise information about the position of the transport vehicle 1. An additional position transmitter 20 can also confirm a position of the transport vehicle 1.

Furthermore, a box 21 is attached to the load carrier 2b.

In FIG. 5, the transport vehicle 1 of FIG. 4 is shown in a schematic perspective view. For the sake of simplicity, here only those elements and functions of the transport vehicle 1 not included in FIG. 4 are discussed. The same parts are provided with the same reference numerals.

In FIG. 5, a first storage level accommodating the load carrier 2a shown in FIG. 4 is tilted upwards. The first storage level formed by the supporting profiles 18 is mounted to a frame part 22. The frame part 22 is fixed to the transport vehicle 1 by means of hinges 23. Gas pressure springs or flexible elements 24 hold the frame part 22 in the tilted position. The gas pressure springs 24 are mounted to storage elements or supports 25 which are used, just as the supports 25′ at the frame part 22, to support the frame part 22 on the transport vehicle 1 and to take on the load of the weights of the storage goods of the storage-goods carriers 2a stored on the frame part 22 or supported by it.

Furthermore, securing means 26 are attached to the frame part 22. The securing means 26 are resting on the supports 25 on the transport vehicle 1 when the frame part 22 and thus the first storage level are tilted down and rest on the vehicle 1 or the side profiles 27 thereof. The securing means 26 can be embodied as simple mechanical closure means 26 which effects catching, locking or for example magnetic holding of the frame part 22 on the storage element 25.

However, it is also absolutely possible to equip the securing means 26 with electronic functions which can, for example, comprise a touch sensor technology, which gives, by a simple electric switch, such as a microswitch or else an inductive or capacitive proximity switch, information about whether the frame part 22 is securely resting on the transport vehicle in a horizontal plane in a closure position V shown in FIG. 4 or is tilted upwards as in an opening position O shown in FIG. 5.

In FIG. 6, another possible embodiment of a transport vehicle 1 according to the invention is shown in a schematic perspective view. The transport vehicle 1 which is shown in FIG. 6 also comprises an undercarriage 13 provided with casters 15 held at rotatable wheel suspensions 14, vertical supports 17 being mounted on said undercarriage 13. Here, the vertical supports 17 are embodied as side walls 17′ at which the supporting profiles 18 are mounted.

The transport vehicle 1 which is shown in FIG. 6 comprises a plurality of storage levels 28 forming an accommodation room 3′ with the supporting profiles or the pairs of supporting profiles 18 arranged one upon the other. The storage-goods carriers 2 can rest with their upper legs 10 as well as with their lower legs 10′ on the storage levels 28, thus increasing the number of effectively usable storage levels. Light grille elements 29 are attached between the supporting profiles. The light grille or storage level detection elements 29 permit a detection of the load carrier stored in the respective storage level 28 assigned to the same as well as a determination of the height of storage goods stored on the load carrier 2.

Catch hooks or latching means 26′ are attached on the storage levels 28 formed by the pairs of supporting profiles 18. The latching means 26′ can grip behind a load carrier 2 at the push-out protections 7′ formed at its supporting webs 9 and prevent an unintentional pulling out of the load carrier from the transport vehicle 1. The latching means 26′ can also be embodied at the transport vehicle 1 in a different manner to hold, lock or otherwise fix a load carrier with a correspondingly embodied counter latching means or a push-out protection 7′. The catch means 26′ is advantageously released from the push-out protection 7′ when the load carrier 2 is to be withdrawn from the transport vehicle 1. This releasing can be effected electronically as well as mechanically and be triggered for example by a positioning of the transport vehicle 1 in the transfer position U.

It is moreover possible for a transfer device 3 to also use a push-out protection 7′ at a load carrier 2 for gripping or transporting the load carrier. Here, however, the edges 7 of the storage-goods carriers 2 essentially extending across the introduction direction Z of the storage-goods carriers 2, which can also fulfill a securing function of the storage-goods carriers 2, similar to the push-out protection 7′, can also be used.

Grips or docking or coupling means 30 are attached to the side walls or the vertical supports 17, respectively, of the transport vehicle 1. The grips 30 permit to hold the transport vehicle 1 to push or pull it by means of a traction vehicle (not shown). The traction vehicle can couple on at the coupling means. The coupling means 30 can be embodied as desired according to the respective requirements and there is no definite special contour or shape. Moreover, the can be used to confirm a proper docking of a traction vehicle.

However, it is also possible for the transport vehicle 1 to be self-propelled. Correspondingly, any energy storages, propulsion motors, direction sensors and a positioning logic as well as electric drive control can be attached to the transport vehicle 1.

Furthermore, the transport vehicle 1 comprises positioning aids 19 and data carriers 11. The positioning aid 19 facilitates precise positioning of the transport vehicle 1 during loading and unloading of storage-goods carriers 2. The data carrier 11 can store data about the storage-goods carriers stored on the transport vehicle 1 or requested by the same and the storage goods located thereon.

In FIG. 7, another possible embodiment of a transport vehicle 1 according to the invention is shown in a schematic perspective view. The transport vehicle 1 which is shown in FIG. 7 also comprises an undercarriage 13 at which casters 15 are rotatably attached. In this possible embodiment of a transport vehicle 1 according to the invention, lifting scissors 31 are mounted on the undercarriage 13. These lifting scissors or lifting means 31 are used to vary the height of the storage levels 29 in the vertical direction Y at the supporting profiles 18. Thus, storage-goods carriers 2 stored on the supporting profiles 18 can be brought to a required loading or unloading height to deposit or withdraw the storage-goods carriers stored with a difference of level ΔY by means of a transfer device 3 on the transport vehicle 1.

The lifting means 31 can also have any other form different from the lifting scissors 31 shown here and only have to be able to vary the storage level 28 on the transport vehicle 1 in the vertical direction Y.

In the possible embodiment which is shown in FIG. 7, the transport vehicle 1 comprises a drive unit 13′. The drive unit 13′ is connected to control means 14′ and drive means 15′ at the suspensions 14 or wheels 15, respectively, by means of electric and/or mechanical connections 13″. The control means 14′ steer the wheels 15 at the suspensions 14. The drive means 15′ drive the wheels 15.

In the drive unit 13′ as well as in the control means 14′ and the drive means 15′, energy storages, motors and power transmission means as well as control means can be arbitrarily combined with each other to steer and advance the transport vehicle 1. In the drive unit 13′, for example, an electrical energy storage and an electrical control can be arranged. These are connected to the control means 14′ and the drive means 15′ by means of the connections 13″. The control means 14′ and the drive means 15′ could be servomotors or electromotors, respectively, which steer and drive the wheels.

Furthermore, the transport vehicle 1 again comprises data carriers 11, positioning aids 19 and position transmitters 20. The data carriers 11, positioning aids 19 and position transmitters 20. These can also be embodied as an integrated logistic module 32 facilitating a positioning of the vehicle 1 in the horizontal direction X or the introduction direction Z or making it possible to detect a height adjustment of the storage level 28 by sensors.

Logistic modules 32 attached in the areas of the storage level 28 can also contain information about the storage-goods carriers 2 individually stored in the storage levels 28 or simply control a height adjustment of the transport vehicle 1 or a transfer device 3 accessing the transport vehicle 1 or assist in controlling the same.

In FIG. 8, further possibilities of how a transport vehicle 1 according to the invention can be embodied are shown. In the transport vehicle 1 shown in FIG. 8, again a plurality of storage levels 28 are formed by the respective supporting profiles 18. Between the supporting profiles 18, storage level detection elements 28 are arranged.

Furthermore, in the introduction direction Z, a positioning aid 19 is attached at the transport vehicle 1. Additionally, the transport vehicle 1 comprises a logistic module 32 pointing in the vertical direction Y which can again be designed as data carrier 11 or position transmitter 20 or positioning aid 19.

In the transport vehicle 1 shown in FIG. 8, lifting means 31 are directly integrated in the undercarriage 13. The lifting elements 13 can also be integrated in the vertical supports or side walls 17′ and bring the vehicle to the height Y required for loading and unloading in each case. It is absolutely conceivable to integrate the lifting means 31 for example in vertical supports 17 as they are shown, for example, in FIG. 4. The lifting means 31 can be embodied, for example, as pneumatic elements.

It is furthermore possible to integrate the supporting profiles 18 directly in the side walls 17′.

In FIG. 9, a possibility of designing the side walls 17′ of a transport vehicle 1 according to the invention is shown Here, the individual storage levels or storage locations 28 are formed by supporting profiles 18 arranged in pairs one upon each other and at a distance to each other, the supporting profiles 18 being used to support supporting webs 9 at the opposed sides of the storage-goods carriers 2.

In the area of a loading and unloading opening or the accommodation room 3′ of the transport vehicle 1, a light grille 29a, 29b is arranged which can be used for measuring the height of the respective storage goods located on the storage-goods carriers and moreover fulfills an additional function in that it can be used to identify and check the position of each of the storage-goods carriers 2 introduced into the loading and unloading opening 3, its vertical position Y as well as its horizontal position Z being detected.

The further functionalities of the transport vehicle 1 shown in FIG. 9 are explained below with reference to FIG. 10 and FIG. 11, wherein a detail IV of the partial view according to FIG. 9 is shown in an enlarged scale and a section along the line V-V in FIG. 9 is shown.

In FIG. 10 and in FIG. 11 it becomes clear that the position determination of the storage-goods carriers 5 is effected with the aid of screens 33 assigned to them. In the particularly advantageous solution represented in the drawings, the screens 33 are provided in the area of the opposed ends or side walls 7 of the storage-goods carriers 2 embodied as grip bars 34. As can be taken from FIG. 11, the respective screen 33 is formed by a side wall 7 of the respective grip bar 34 provided with a window 35. The dimensions of the side wall 7 and of the window 35 are in this case adapted to a spacing t of the storage level detection elements or light barriers 29 of the light grille 29a, 29b, such that one light beam each passes the screen 33 and one light beam is interrupted, i.e. stopped down by the screen 33. While the passing light beam is used to determine the position of the respective load carrier 2, the interrupted light beam is used to inform a control system that a load carrier 2 is situated in the area of the loading and unloading opening 6, 6′. The spacing t corresponds to half a distance A between the respective subsequent supporting profiles 18.

Thus, this embodiment of a transport vehicle 1 according to the invention offers the advantage that particular sensors 29 for checking the proper position of the load carrier 2 in the loading and unloading opening 6, 6′ of a storage rack 4 or the vehicle 1 itself can be eliminated. Such a check is inevitable to ensure a perfect transfer of the load carrier 2 from the loading and unloading opening 6, 6′ to a transfer device 3 or else to a vertical conveyor 36. The functionality of such a vertical conveyor 36 will be illustrated in detail below.

In FIG. 12, a schematic perspective view of a storage rack or a storage lift 4 of a schematic perspective view is shown. FIG. 13 shows the storage lift 4 without parts of its side covering in a further schematic perspective view.

The storage lift 4 which is shown in FIGS. 12 and 13 comprises two rack columns 37 and 38 which limit a shaft 39. In the shaft 39, a vertical conveyor 36 equipped with a horizontal conveyor means 40 can be moved upwards and downwards to transfer storage-goods carriers 2 at various locations 28′ of the rack columns 37 or 38, respectively. The individual storage locations 28′ are formed by supporting profiles 18′ arranged in pairs one upon the other and at a distance to each other, the supporting profiles 18′ being used to support the supporting webs 9 at the opposed sides of the storage-goods carriers 2.

Alternatively, a storage lift 4 can also be embodied as a circulating rack in which the storage-goods carriers 2 are circulated horizontally and/or vertically to the loading and unloading opening 6.

In the storage lift 4 shown in FIG. 12 and FIG. 13, supporting profiles 18′ are also provided in the loading and unloading opening 6 which permit an introduction of storage-goods carriers 2 at different heights of levels Y of the loading and unloading opening. The respective operator consequently has the possibility of pushing the storage-goods carriers 2 to a position in the storage lift 4 which is ergonomically optimal.

If required, in the rear portion of the loading and unloading opening 6 of the storage lift 4, a light grille 29′ can be arranged which can detect the heights of storage goods stored on the storage-goods carriers 2 and determine the position of the storage-goods carriers 2.

In FIG. 14, a transfer device 3 according to the invention is shown in a schematic perspective view. The transfer device 3 is mounted in front of a loading and unloading opening 6 of a rack storage or storage lift 4, respectively.

The transfer device 3 is mounted on a lifting table which is provided with lifting scissors or lifting means 31′. Thus, the lifting table 41 can drive the transfer device 3 to a desired storage level 28 of a transport vehicle 1 to deposit or withdraw storage-goods carriers 2 at different heights Y on the transport vehicle 1.

A transport vehicle 1 drives to the transfer device 3 in the introduction direction Z. The transfer device 3 comprises positioning aids 19′ and position transmitters 20′ which facilitate, as counterparts to the positioning aids 19 and the position transmitters 20 of the transport vehicle 1, a precise positioning of the transport vehicle at the transfer device 3.

The positioning aids 19 and the position transmitters 20 can be embodied at the transport vehicle, and the positioning aids 19′ and the position transmitters 20′ can be embodied at the transfer device, each as sensor transmitter pairs assigned to each other. The positioning aid 19′ can be e.g. a sensor 19′ which is adapted to a transmitter or position transmitter 20 at the vehicle 1. The transmitter or position transmitter 20′ at the transfer device 3 can in turn be adapted to the positioning aid 19 at the vehicle. The transmitter 20′ at the transfer device 3 can report that there is a vehicle 1 in front of the transfer device 3. The transmitter 20 at the vehicle can subsequently give a feedback saying whether the loading or unloading process is to be or can be performed.

As sensor transmitter pairs, for example inductive proximity switches 20, 20′ and corresponding magnets 19, 19′ can be employed. However, beyond this it is also possible to employ optical sensors or other radio or proximity sensors.

Correspondingly, the positioning aids 19 and the position transmitters 20 at the transport vehicle 1 represent positioning means 19, 20 for the positioning aids 19′ and position transmitters 20′ embodied as counter positioning means 19′, 20′ and to be assigned to the storage rack 4.

Furthermore, the transfer device 3 has a data transmission device 42. The data transmission device 42 can read in and out information from the data carriers 11 or the logistic modules 32 at the transport vehicle 1 or its storage levels 28 or directly at the storage-goods carriers 2. However, the data transmission device 42 can also be employed as additional positioning aid and be of assistance, for example, in detecting the corresponding loading heights Y of the storage-goods carriers 2 on the transport vehicle 1.

Moreover, it can be seen in FIG. 14 that a storage lift or storage rack 4 with diverse storage places 28′ and a vertical guiding system 43 for a vertical conveyor 36 is located behind the loading and unloading opening 6.

In FIG. 15, the transfer device 3 according to the invention of FIG. 14 is shown in a further schematic perspective view. Behind the loading and unloading opening 6, the storage rack 4 can be seen again with its storage locations 28 and a vertical drive 44 for the vertical conveyor 36. The vertical drive 44 can be embodied directly as toothed rack in a wall of the storage lift 4, but also as simple chain or belt drive or some other drive device permitting the propulsion of the vertical conveyor 36.

The lifting scissors table 41 which is movable in the vertical direction Y is mounted in front of the loading and unloading opening 6. With its lifting scissors or lifting means 31′ it can drive the working level (E) of the transfer device 3 to a desired working or loading and unloading height Y at the transport vehicle 1. Subsequently, a horizontal conveyor 40′ at the transfer device is used to deposit and withdraw the storage-goods carriers 2 in the storage goods levels 28 of the transport vehicle 1 and to transport them to the vertical conveyor 36.

Catch hooks or latching means 26″ can be embodied on the horizontal conveyor 40′, which can grip behind the push-out protections 7′ or other latching aids at the storage-goods carriers. Alternatively, elements of the horizontal conveyor 40′ can also directly grip behind the grip bars 34 or the edges 7 of the storage-goods carriers 2 or engage with them to push a load carrier out of or into its storage level 28 on the transport vehicle 1.

Furthermore, the transfer device 3 comprises, in addition to the data transmission device 42, data transmission devices 42′ and 42″ which can each detect and read in and out logistic modules 32 or data carriers 11 at the transport vehicle or the storage-goods carriers each pointing in the vertical direction Y and the horizontal direction X.

The transfer device 3 can be mounted in front of an existing storage rack 4 or storage lift 4 so that an already existing storage system does not have to be modified and the transport vehicle 1 according to the invention can nevertheless be used in a storage system 5 according to the invention.

In FIG. 16, a transport vehicle 1 according to the invention is shown in a further possible embodiment in a schematic perspective view. The transport vehicle 1 comprises introduction aids 45. These introduction aids 45 in the form of laterally attached run-in casters 45 facilitate the approach of the transport vehicle 1 to a transfer device 3 or to a storage lift or rack storage 4′ as shown in FIG. 17.

In FIG. 17, a storage system 5′ is shown in a schematic perspective view. The storage system 5′ comprises a storage lift 4′ comprising a loading and unloading opening 6 which is embodied as entrance 6′ for a transport vehicle 1 according to the invention. The transport vehicle 1 can drive directly into the storage lift 4′ via the entrance 6′.

In the storage lift 4′, the transport vehicle 1 can drive near a vertical conveyor 36′, or the transport vehicle is positioned above or at a logistic module 32 or positioning means 19′, 20′, 32, and the vertical conveyor 40′ drives to the transport vehicle 1. For this, the vertical conveyor 40′ comprises a horizontal moving system or horizontal rails 46 with the aid of which the vertical conveyor 40 can be moved into the storage lift 4′ in the horizontal direction X.

Another logistic module or positioning means 19′, 20′, 32 is attached to the vertical conveyor 40′, which positioning means can be embodied as data transmission means 42 as well as position transmitter 20′ and/or positioning aid 19′.

The vertical guide 43, which is anyway provided at the vertical conveyor 40′, and a corresponding vertical drive system 44 permit to drive the vertical conveyor 36′ to a corresponding storage level 28 at the transport vehicle 1 to there withdraw or deposit the storage-goods carriers 2a, 2b.

After the vertical conveyor 36′ has deposited or withdrawn the storage-goods carriers 2a, 2b on the transport vehicle, the vertical conveyor 36′ can drive over its rail and drive system 43, 44, 46 to the corresponding storage positions 28′ in the storage system 5′ and further deposit and withdraw storage-goods carriers 2.

To deposit or withdraw the storage-goods carriers 2 on or from the transport vehicle 1, the vertical conveyor 36′ has a horizontal conveyor device 40′ which can push the storage-goods carriers 2 into or from their respective introduction positions or storage levels 28 at the transport vehicle.

To facilitate driving the transport vehicle into and out of the storage rack 4′, the transport vehicle 1 comprises the introduction aids 45 already shown in FIG. 16. These introduction aids 45 facilitate driving the transport vehicle 1 into the entrance 6′ of the storage rack 4′.

To this end, at the storage rack 4′ in the area of the entrance 6′, additional run-in slopes 47 or run-in aids 47 are attached laterally. These run-in slopes act as a funnel at which the transport vehicle 1 is guided into the storage rack 4′.

The run-in slopes can additionally be equipped with light barriers or storage level detection elements 29′ pointing to the introduction direction Z as well as to the horizontal direction X. The light barriers or light grille elements and storage level detection elements 29′ can detect storage-goods carriers 2 stored on the transport vehicle 1. However, they can also be of assistance in reporting the entering of a transport vehicle 1 into the storage rack 4′ or in ensuring personal security.

For personal security reasons, for example the storage lift should no longer be moved as soon as a light grille formed by light grille elements 29′ is interrupted by a person located in the entrance. It is also possible to install such a light grille or light grille element 29′ in front of a transfer device 3 so that a storage system 5, 5′ according to the invention can detect persons located near or in a loading and unloading opening 6 or the entrance 6′ and adjust its operation mode accordingly or completely interrupt the operation.

Within the scope of the inventive idea, deviations from the above-described embodiments are possible. For example, the elements of the transport vehicle 1, the storage lifts or rack storages 4, 4′ and the transfer devices 3 as well as storage-goods carriers 2 can be arbitrarily combined and adapted to each other.

Loading and unloading openings 6 or entrances 6′ can be arbitrarily designed so that a transport vehicle 1 can drive near them or into them to load and unload an arbitrary number of storage-goods carriers or trays 2 transported on it.

The edge 7 around the storage area 8 of the storage-goods carriers 2 can have an arbitrary embodiment to limit the storage area 8 or function as grip bar 34, so that the load carrier 2 can be loaded or unloaded manually or by means of a pusher 26″ or a horizontal conveyor means 40 in a storage rack or on a transport vehicle 1. Supporting webs 9 can be formed in an arbitrary manner with legs or jaws 10 and 10′ so that the load carrier 2 can be retained in a suited manner in storage levels 28, 28′ formed by arbitrarily designed supporting profiles 18, 18′.

Data carriers 11, positioning aids 19, 19′ and position transmitters 20, 20′ can be arbitrarily designed as positioning means 19, 19′, 20, 20′ to fulfill their respective functions, and they can be arbitrarily combined to form logistic modules 32 to form, individually or in groups, a docking station in the area of a loading and unloading opening 6 or in an entrance 6′ to which a transport vehicle 1 which is equipped with an arbitrary number of data carriers 11, positioning aids 19 and position transmitters 20, which can be also combined to form logistic modules 32, can drive or be automatically approached and oriented and precisely positioned in the horizontal, introduction and vertical directions X, Z, Y.

This positioning can be performed by the vehicle itself as well as with the aid of transfer devices 3, vertical conveyors 36, 36′, lifting tables 41, lifting means 31, 31′ and casters 15 at arbitrarily designable suspensions 14. These elements can be arbitrarily combined with each other to permit loading and unloading of storage-goods carriers 2 in a plurality of storage levels 28 or 28′ on a transport vehicle in a storage rack or a storage lift 4, 4′, respectively.

Here, a plurality of arbitrarily designable data transmission devices 42 can be arranged in the area of a docking station of a storage lift 4, 4′, its loading and unloading opening 6′ or entrance, or they can alternatively also be attached at the transport vehicle 1 or a motor car driving the transport vehicle 1 to transmit data on the type and number of storage-goods carriers present on the transport vehicle 1 or in the storage racks 4, 4′ and to be deposited and withdrawn, and of the goods stored on the storage-goods carriers, or to read them out of or into data carriers 11 and logistic modules 32.

The transport vehicle can be equipped with an arbitrary number of arbitrarily designable grips or docking or coupling means 30 so that it can be moved manually or by a motor car guided automatically or by a person.

In a self-propelled transport vehicle 1, the drive unit 13′, connections 13″, control means 14′ and drive means 15′ can be arbitrarily combined with each other as well as with positioning aids 19, position transmitters 20, logistic modules 32 and data transmission devices 42 to drive the transport vehicle 1 automatically into or near the transfer position U. Here, the drive unit 13′ can also be used for driving or supplying and controlling lifting means 31.

On the transport vehicle, an arbitrary number of storage levels 28 can be arranged with hinges 23, flexible elements 24 and supports 25 on frame parts 22 or vertical supports 17 to meet the respective demands on a manual or automatic loading and unloading of storage-goods carriers 2 and of storage goods stored in boxes 21 which can be arbitrarily arranged and embodied in or on the storage-goods carriers 2.

The storage-goods carriers 2 can be arbitrarily provided with push-out protections or catch hooks 7′ which act essentially across the possible moving senses B of the vehicle or the introduction direction, so that they prevent unintentional pulling in and out of a load carrier from a storage level. This can be in particular necessary if storage-goods carriers 2 are stored in a frame part 22 that can be transferred from a closure position V to an open position O, from which frame part 22 they can slip down.

However, for example push-out protections and catch hooks 7, 26′, 26″ formed as cams or latching means engaging storage-goods carriers 2 can also be useful to prevent a slipping out of the load carrier 2 when the vehicle 1 is braking during a docking operation, and which are electronically and/or mechanically released when a loading and unloading readiness is confirmed, so that one or several storage-goods carriers 2 are released from a latching position R in which they are protected from being pulled out of a storage level 28, 28′ and transferred to a transport readiness T.

A mechanical and/or electronic confirmation of a latching position R can also be used to release a transport vehicle 1, a transfer device 3 or a vertical conveyor 36, 36′, so that it is only moved when a latching position R has been confirmed.

A transport readiness T to be confirmed electronically and/or mechanically can in turn be used to release the operation of horizontal conveyor devices 40 mounted on a transfer device 3 or a vertical conveyor 36, 36′ as well as possibly also on the transport vehicle 1 itself, so that they deposit and withdraw storage-goods carriers 2 on or from a transport vehicle 1 or in and from a storage rack 4, 4′.

During all these processes, an arbitrary number of light grilles or storage level detection elements 29, 29′ as well as light grilles 29a and 29b can be employed to arbitrarily detect a proper positioning, existence, latching position R or transport readiness T of storage-goods carriers 2 with the aid of windows 35 and covers 33 formed at the storage-goods carriers 2, and/or to determine the height, width and/or depth of storage goods stored on the storage-goods carriers 2.

Such a detection and determination of the height of storage goods make it possible to optimally utilize the storage space available on a transport vehicle 1 in a storage rack 4, 4′ and on vertical conveyors 36, 36′ and to perform automated storage compacting wherein the storage-goods carriers 2 are optimally stored according to the dimensions of goods stored on them one upon and underneath the other in storage levels 28 on the transport vehicle 1 and in the storage racks 4, 4′.

Here, the distance A between the storage levels or the supporting profiles can be selected according to the respective requirements, where it is advantageous if additionally a reasonable spacing t of the light barriers 29a, 29b can be realized. Here, it is again advantageous if several storage possibilities are provided at the storage-goods carriers 2, for example with upper and lower legs 10, 10′ of the supporting webs which can utilize a multiple of the storage locations 28, 28′ provided by the storage levels 28, 28′ with the distance A.

The difference of level ΔY between the storage-goods carriers 2 can correspond to the distance A as well as to the fractions of distance A achieved by the upper and lower legs 10, 10′.

The supporting profiles 18, 18′ can in turn have any design to fulfill their respective purpose of holding a load carrier 2. They can be mounted at vertical profiles 17 or else supporting profiles 18 of a transport vehicle 1, its external walls 17′ or a frame part 22 with a form-fit or material connection However, it is also possible to directly integrate them in a side wall 17′ of the vehicle or even to form them integrally with the side wall 17′, where they can be arbitrarily formed of sheet metals or other materials.

1. Method of automatically depositing and withdrawing storage-goods carriers (2) in and from a storage rack (4, 4′), wherein at least two storage-goods carriers (2) are stored in each a first and at least one other storage level (28) one upon the other on a transport vehicle (1), the transport vehicle (1) is driven near the rack storage (4, 4′) and positioned at the storage rach (4, 4′) in a transfer position (U), and subsequently the storage-goods carriers (2) of the first and then of the at least one other storage level (28) are deposited in or withdrawn from the storage rack (4, 4′) in the transfer position (U), wherein a relative difference of level (ΔY) between a working level (E) of a transfer device (3, 36, 36′) and the respective storage levels (28) of the storage-goods carriers (2) is automatically compensated for deposition and withdrawal.

2. Method according to claim 1, characterized in that the transfer position (U) is confirmed with the aid of a positioning means (19, 19′, 20, 20′) at the transport vehicle (1) and/or the storage rack (4, 4′).

3. Method according to claim 1, characterized in that an unloading readiness of the transport vehicle (1) is confirmed with the aid of a positioning means (19, 19′, 20, 20′) at the transport vehicle (1) and/or at the storage rack (4, 4′).

4. Method according to claim 1, characterized in that the transport vehicle (1) is automatically positioned in the transfer position (U).

5. Method according to claim 1, characterized in that the storage-goods carriers (2) are pushed into and/or out of the storage levels (28) of the transport vehicle with the aid of horizontal conveyor device (40).

6. Method according to claim 5, characterized in that before the pushing in and/or out of the storage-goods carriers (2), a push-out protection (7′) is released.

7. Method according to claim 1, characterized in that at the latest in the transfer position (U), a data carrier (11) is read in or out at the transport vehicle (1) and/or the storage-goods carriers (2).

8. Method according to claim 1, characterized in that during the approach of the transport vehicle (1) to the storage rack (4, 4′), light grille elements (29′) at the storage rack (4, 4′) are switched on.

9. Method according to claim 8, characterized in that the light grille elements (29′) and/or light grille elements (2) at the transport vehicle (1), the presence of storage-goods carriers (2) on the first and on the at least one further other storage level (28) on the transport vehicle is detected.

10. Method according to claim 9, characterized in that with the light grille elements (29′) of the storage rack (4, 4′) and/or the light grille elements (29) of the transport vehicle (1), a height of storage goods on the storage-goods carriers (1) is detected.

11. Method according to claim 1, characterized in that the transfer device (3, 36, 36′) and/or the storage levels (28) of the transport vehicle (1) are moved with a lifting means (31, 31′, 43, 44) in a vertical direction (Y) to deposit or withdraw the storage-goods carriers (2) in or from their respective storage levels (29) of the transport vehicle (1).

12. Method according to claim 1, characterized in that the transport vehicle (1) drives into an entrance (6′) in a storage rack (4, 4′).

13. Method according to claim 12, characterized in that the driving of the transport vehicle (1) into the entrance (6′) is guided with at least one run-in aid (47) at the entrance (6′).

14. Method according to claim 1, characterized in that during an approach of the transport vehicle (1) to the transfer device (3, 36, 36′), the accuracy of the position finding of the transport vehicle (1) is increased.

15. Method according to claim 1, characterized in that the transport vehicle (1) is driven near the transfer device (3, 36, 36′) by an external drive unit.

16. Method according to claim 15, characterized in that the external drive unit is coupled to the transport vehicle (1) before the transport vehicle (1) is moved.

17. Method according to claim 16, characterized in that the external drive unit is uncoupled at the latest in the transfer position (U) of the transport vehicle (1).

18. Method according to claim 1, characterized in that at least one storage level (28) of the transport vehicle (1) is tilted away from the storage level (28) situated below for loading and unloading a storage level (28) situated below.

19. Transport vehicle (1) for transporting storage-goods carriers (2) to a storage rack (4, 4′) or away from the same, having at least two storage levels (28) for the storage-goods carriers (2) arranged one upon the other, a positioning means (19, 20) which is designed such that it can be aligned with a counter-positioning means (19′, 20′) which can be assigned to the storage rack (4, 4′) and by which the transport vehicle (1) can be positioned in a defined transfer position (U) at the storage rack (4, 4′), wherein in the transfer position (U) the storage-goods carriers (2) can be deposited in or withdrawn from their storage levels (29) one after the other.

20. Transport vehicle (1) according to claim 19, characterized in that the transport vehicle is provided with a data carrier (11) in which information about at least one load carrier stored on the transport vehicle (1) and/or requested by the transport vehicle can be read in and/or out.

21. Transport vehicle (1) according to claim 19, characterized in that at least one storage level (28) is fixed to the transport vehicle (1) by means of at least one hinge (23) so that it can be tilted.

22. Transport vehicle (1) according to claim 19, characterized in that at least one storage level (28) is formed by at least one supporting profile (18).

23. Transport vehicle (1) according to claim 19, characterized in that the at least one supporting profile (18) is formed at a wall element (17′).

24. Transport vehicle (1) according to claim 20, characterized in that at at least one storage level (28), at least one light grille element (29) is arranged.

25. Transport vehicle (1) according to claim 19, characterized in that the transport vehicle (1) comprises a lifting means (31) with which at least one storage level (28) of the transport vehicle (1) can be moved in a vertical direction (Y).

26. Storage rack (4, 4′) for storing storage-goods carriers (2), having at least one storage level (28′), at least one counter-positioning means (19′, 20′) cooperating with at least one positioning means (19, 20) at a transport vehicle (1), wherein the transport vehicle can be aligned with said counter-positioning means (19, 20) in a transfer position (U), and having a transfer device (3, 36, 36′) the working level (E) of which can be relatively brought to the same level as a first and at least one other storage level (28) arranged one upon the other on the transport vehicle (1), by which transfer device one can access a load carrier (2) stored in the first and/or at least one second storage level (28) of the transport vehicle (1) can be accessed in the transfer position (U).

27. Storage rack (4, 4′) according to claim 26, characterized in that the transfer device (3, 36, 36′) is provided with at least one lifting means (31, 31′, 43, 44).

28. Storage rack (4, 4′) according to claim 26, characterized in that the at least one transfer device (3, 36, 36′) is at least partially arranged in an interior (39′) of the storage rack (4, 4′) which comprises at least one entrance (6′) into which at least a part of the transport vehicle (1) can drive for reaching the transfer position (U).

29. Method according to claim 2, characterized in that an unloading readiness of the transport vehicle (1) is confirmed with the aid of a positioning means (19, 19′, 20, 20′) at the transport vehicle (1) and/or at the storage rack (4, 4′).

30. Transport vehicle (1) according to claim 20, characterized in that at least one storage level (28) is fixed to the transport vehicle (1) by means of at least one hinge (23) so that it can be tilted.
